(19) United States
(12) Patent Application Publication
(10) Pub. No.: US 2010/0144207 A1
(43) Pub. Date: Jun. 10, 2010

(54) CONNECTION DEVICE

(75) Inventor: Xiang Yuan, Shenzhen (CN)

Correspondence Address: FutureWei Technologies, Inc.;IPR & Standards Department, 1700 Alma Drive, Suite 500, Plano, TX, 75075, US

(73) Assignee: SHENZHEN HUAWEI COMMUNICATION TECHNOLOGIES CO., LTD., Shenzhen (CN)

(21) Appl. No.: 12/607,982

(22) Filed: Oct. 28, 2009

(30) Foreign Application Priority Data
Dec. 8, 2008 (CN) 200820180670.6

(51) Int. Cl. H01R 24/00

(52) U.S. Cl. 439/660

(57) ABSTRACT

A connecting device includes a first connector and a second connector. The first contact point of the first connector is located in the recess of the second connector and contacts with the second contact point when the first connector and the second connector are in the primary position; and the first contact point of the first connector is separated from the second contact point in the recess of the second connector when the first connector or the second connector is rotated to the secondary position around the shaft. The disclosure allows the first connector and the second connector to easily switch between the connected status and disconnected status to enhance the operation experience of a user.

### CROSS-REFERENCE TO RELATED APPLICATION

This application claims priority to Chinese Patent Application No. 200820180670.6, filed Dec. 8, 2008, which is hereby incorporated by reference in its entirety.

### FIELD OF THE INVENTION

The disclosure relates to a network technology field, and in particular, to a connecting device.

### BACKGROUND

At present, different network devices are connected through data lines. When data is transmitted or data connection is disconnected between devices, a connector of a data line needs to be plugged and pulled correspondingly.

In the process of implementing the disclosure, the inventor finds that finds the following problems in the existing technology:

when a connector of a data line is plugged and pulled repeatedly, the connector is easily damaged, resulting in low operation efficiency and poor operation experience.

### SUMMARY

A connecting device is provided herein to improve the efficiency of switching between connected and disconnected statues of a data line and enhance the operation experience of a user.

A connecting device is provided in an embodiment of the disclosure. The device includes a first connector and a second connector.

The first connector is connected to the second connector through a shaft.

The first contact point which is convex is provided on the plane of the first connector docking with the second connector.

The second contact point is provided in the recess on the plane of the second connector docking with the first connector

The first contact point of the first connector is located in the recess of the second connector and contacts with the second contact point when the first connector and the second connector are in the primary position.

The first contact point of the first connector is separated from the second contact point in the recess of the second connector when the first connector or the second connector is rotated to the secondary position around the shaft.

A connecting device is provided in an embodiment of the disclosure. The device includes a first data line, a second data line, a first connector, and a second connector.

The first data line is connected to the first connector, the second data line is connected to the second data line; and the first connector is connected to the second connector through a shaft.

The first contact point which is convex is provided on the plane of the first connector docking with the second connector.

The second contact point is provided in the recess on the plane of the second connector docking with the first connector.

The first contact point of the first connector is located in the recess of the second connector and contacts with the second contact point when the first connector and the second connector are in the primary position, and the first data line is connected to the second data line.

The first contact point of the first connector is separated from the second contact point in the recess of the second connector when the first connector or the second connector is rotated to the secondary position around the shaft, and the first data line is disconnected from the second data line.

One embodiments of the present disclosure provides a connecting device. The first connector and the second connector on the connecting device are rotated to opposite directions to cause a change of position, so that the first connector and the second connector switch between connected status and disconnected status, thus simplifying the operation and enhancing the operation experience of a user.

### BRIEF DESCRIPTION OF THE DRAWINGS

To explicitly explain the technical solution in the embodiment of the disclosure, the figures used in this embodiment are described as follows. Obviously, the following figures illustrate embodiments of the disclosure, based on which other figures can be obtained by those skilled in the art without creative work.

FIG. 1 shows a structure of a connecting device provided in an embodiment of the disclosure;

FIG. 2 shows a structure of a connecting device in the connected status provided in an embodiment of the disclosure;

FIG. 3 shows a structure of a connecting device in the disconnected status provided in an embodiment of the disclosure;

FIG. 4 shows a structure of the plane in the A direction of the first connector provided in an embodiment of the disclosure; and

FIG. 5 shows a structure of the plane in the B direction of the second connector provided in an embodiment of the disclosure.

### DETAILED DESCRIPTION

The following section explicitly describes the complete technical solution provided in the embodiments of the disclosure by referring to relevant figures. Obviously, only a few embodiments of the disclosure are provided herein. All other embodiments obtained by those skilled in the art without creative work based on the embodiments of the disclosure are protected by the disclosure.

A connecting device is provided in an embodiment of the disclosure. The device includes a first connector and a second connector.

The first connector is connected to the second connector through a shaft. The first contact point which is convex is provided on the plane of the first connector that contacts with the second connector. The second contact point is provided in the recess on the plane of the second connector for contact.

The first contact point of the first connector is located in the recess of the second connector and contacts with the second contact point when the first connector and the second connector are in the primary position.

The first contact point of the first connector is separated from the second contact point in the recess of the second connector when the first connector or the second connector is rotated to the secondary position around the shaft.

The shaft is fixedly mounted on the first connector or the second connector; one or more first contact points exist; one or more second contact points exist; one or more recesses exist; and the first connector and the second connector have ports respectively for external data lines.

A connecting device is provided in another embodiment of the disclosure. The connecting device includes a first connector and a second connector.

The first connector is connected to the second connector through a shaft. The shaft is approximately perpendicular to the docking plane of the first connector or the docking plane of the second connector. The first connector or the second connector can be rotated along the shaft.

A first contact point which is convex is provided on a plane of the first connector docking with the second connector. A second contact point is provided in a recess on a plane of the second connector docking with the first connector. The docking plane of the first connector may not contact the docking plane of the second connector.

The first contact point of the first connector is located in the recess of the second connector and contacts with the second contact point when the first connector and the second connector are in a primary position.

The first contact point of the first connector is separated from the second contact point in the recess of the second connector when the first connector or the second connector is rotated to a secondary position around the shaft.

Optionally, the shaft is fixedly mounted on the first connector or the second connector; one or more first contact points exist; one or more second contact points exist; one or more recesses exist; and the first connector and the second connector have ports respectively for external data lines. The number and position of the first contact point can be one-to-one corresponding to that of the second contact points.

In embodiments of the disclosure, the first connector and the second connector on the connecting device are rotated to opposite directions to cause a change of position, so that the first connector and the second connector switch between the connected status and disconnected status, thus simplifying the operation and enhancing the operation experience of a user.

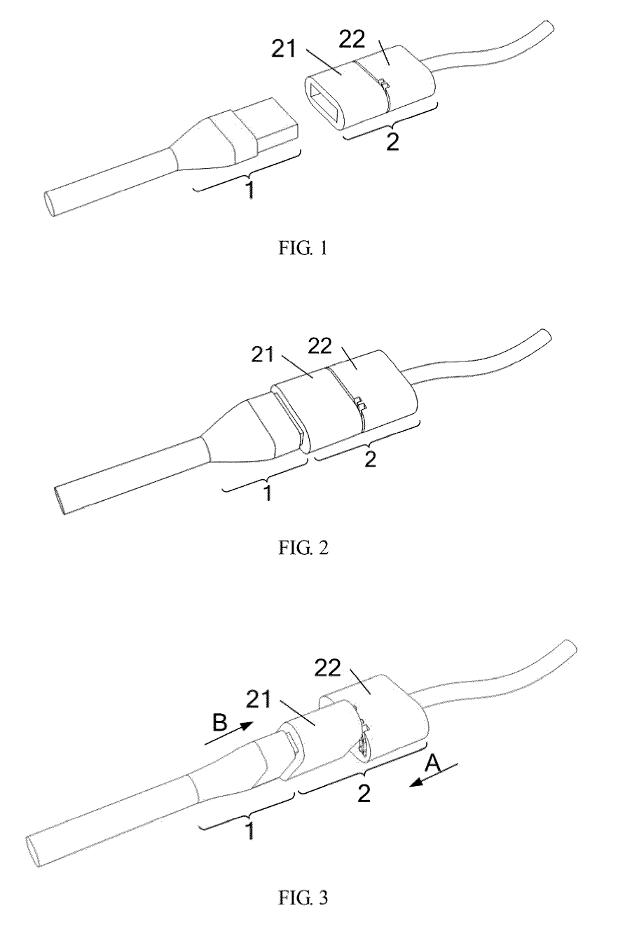

The following section describes the structure of a connecting device provided in the embodiments of the disclosure in detail by referring to the relevant figures. As shown in FIG. 1, the device includes a data connector 1 and a connecting device 2 provided in an embodiment of the disclosure, and the connecting device 2 includes a first connector 21 and a second connector 22.

The first connector 21 can be connected to the data connector 1 in a mode shown in FIG. 1. The connection mode is not limited in an embodiment of the disclosure. The second connector 22 is connected to a data line in a mode that is not limited in an embodiment of the disclosure. The following section describes the structure of the connecting device 2 by referring to FIG. 2 to FIG. 5.

FIG. 2 shows a structure of the connecting device 2 in the connected status; and FIG. 3 shows a structure of the connecting device 2 in the disconnected status. The connected and disconnected statuses of the connecting device 2 are switched through the relative rotation of the first connector 21 and the second connector 22.

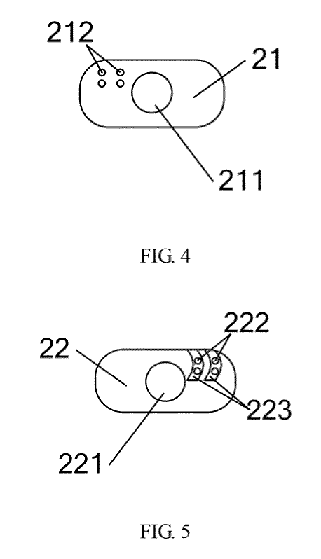

Specifically, FIG. 4 shows the contact plane structure of the first connector from the A direction (for which, refer to FIG. 3), provided in an embodiment of the disclosure. As shown in FIG. 4, the first connector 21 includes a rotation part 211. Through the component 211, the first connector 21 can be rotated relatively to the second connector 22. The first contact point 212 is provided on the plane of the first connector 21 that contacts with the second connector 22.

Specially, FIG. 5 shows a contact plane structure of the second connector from B direction (for which, refer to FIG. 3), provided in an embodiment of the disclosure. As shown in FIG. 5, the second connector 22 includes a rotation part 221. Through the component 221, the second connector 22 can be rotated relatively to the first connector 21. The recess is provided on the plane of the second connector 22 that contacts with the first connector 21. The second contact point 222 is provided in the recess 223.

It is understandable that the rotation part 211 of the first connector 21 and the rotation part 221 of the second connector 22 can be a shaft and a hole for occupying the shaft.

When the first connector 21 and the second connector 22 are in the connected status shown in FIG. 2, the first contact point 212 on the first connector 21 is located in the recess 223 of the second connector 22 and contacts with the second contact point 222, so that the data connection is established through the first connector 21 and the second connector 22.

When the first connector 21 and the second connector 22 are rotated relatively, the first contact point 212 on the first connector 21 moves along the rotation track. When the first contact point 212 on the first connector 21 is in the status shown in FIG. 3, the first contact point 212 is separated from the recess 223 of the second connector 22, and contacts with the second contact point 222. In this case, the data connection established by the first connector 21 and the second connector 22 is disconnected.

The preceding embodiment is only an optional implementation method of the structure of connecting device provided in the disclosure, and not used to limit the protection scope of the disclosure. In the implementation mode of rotating the connecting device, the change of the quantity, location, and shape of the first contact point, the second contact point, and the recess are protected by the disclosure.

A connecting device is also provided in an embodiment of the disclosure. The device includes a first data line, a second data line, a first connector, and a second connector.

The first data line is connected to the first connector, the second data line is connected to the second data line, and the first connector is connected to the second connector through a shaft.

The first contact point which is convex is provided on the plane of the first connector that contacts with the second connector.

The second contact point is provided in the recess on the plane of the second connector that contacts with the second connector.

The first contact point of the first connector is located in the recess of the second connector and contacts with the second contact point when the first connector and the second connector are in the primary position, and the first data line is connected to the second data line.

The first contact point of the first connector is separated from the second contact point in the recess of the second connector when the first connector or the second connector is rotated to the secondary position around the shaft, and the first data line is disconnected from the second data line.

The shaft is fixedly mounted on the first connector or the second connector; one or more first contact points exist; one or more second contact points exist; and one or more recesses exist.

A connecting device is also provided in another embodiment of the disclosure. The connecting device comprises a first data line, a second data line, a first connector, and a second connector. The first data line is connected to the first connector, the second data line is connected to the second data line; and the first connector is connected to the second connector through a shaft. The shaft is approximately perpendicular to the docking plane of the first connector or the docking plane of the second connector. The first connector or the second connector can be rotated along the shaft.

A first contact point which is convex is provided on a plane of the first connector docking with the second connector. A second contact point is provided in a recess on a plane of the second connector that docking with the first connector. The docking plane of the first connector may not contact the docking plane of the second connector.

The first contact point of the first connector is located at the recess of the second connector and contacts with the second contact point when the first connector and the second connector are in a primary position, and the first data line is connected to the second data line.

The first contact point of the first connector is separated from the second contact point in the recess of the second connector when the first connector or the second connector is rotated to a secondary position around the shaft, and the first data line is disconnected from the second data line.

Optionally, the shaft is fixedly mounted on the first connector or the second connector; one or more first contact points exist; one or more second contact points exist; one or more recesses exist; and the first connector and the second connector have ports respectively for external data lines. The number and position of the first contact point can be one-to-one corresponding to that of the second contact points.

In an embodiment of the disclosure, the first connector and the second connector on the connecting device are rotated relatively to cause a change of position, so that the first connector and the second connector switch between the connected status and disconnected status, thus simplifying the operation and enhancing the operation experience of a user.

The sequence number of the preceding embodiments of the disclosure is just for description but does not indicate the good or bad embodiments.

The preceding embodiments are several specific embodiments disclosed in the disclosure. However, those modifications made on these embodiments by those skilled in the art are protected by the disclosure.

What is claimed is:

1. A connecting device, comprising a first connector and a second connector, wherein:
the first connector is connected to the second connector through a shaft;
a first contact point which is convex is provided on a plane of the first connector docking with the second connector;
a second contact point is provided in a recess on a plane of the second connector docking with the first connector;
the first contact point of the first connector is located in the recess of the second connector and contacts with the second contact point when the first connector and the second connector are in a primary position; and
the first contact point of the first connector is separated from the second contact point in the recess of the second connector when the first connector or the second connector is rotated to a secondary position around the shaft.

2. The connecting device according to claim 1, wherein the shaft is fixedly mounted on the first connector or the second connector.

3. The connecting device according to claim 1, wherein one or more first contact points exist.

4. The connecting device according to claim 1, wherein one or more second contact points exist.

5. The connecting device according to claim 1, wherein one or more recesses exist.

6. The connecting device according to claim 1, wherein the first connector and the second connector have ports respectively for external data lines.

7. A connecting device, comprising a first data line, a second data line, a first connector, and a second connector; wherein:
the first data line is connected to the first connector, the second data line is connected to the second data line; and the first connector is connected to the second connector through a shaft;
a first contact point which is convex is provided on a plane of the first connector that docking with the second connector;
a second contact point is provided in a recess on a plane of the second connector docking with the first connector;
the first contact point of the first connector is located at the recess of the second connector and contacts with the second contact point when the first connector and the second connector are in a primary position, and the first data line is connected to the second data line; and
the first contact point of the first connector is separated from the second contact point in the recess of the second connector when the first connector or the second connector is rotated to a secondary position around the shaft, and the first data line is disconnected from the second data line.

8. The connecting device according to claim 7, wherein the shaft is fixedly mounted on the first connector or the second connector.

9. The connecting device according to claim 7, wherein one or more first contact points exist.

10. The connecting device according to claim 7, wherein one or more second contact points exist, and one or more recesses exist.

11. The connecting device according to claim 7, wherein one or more recesses exist.
